(19) United States
(12) Patent Application Publication
(10) Pub. No.: US 2026/0171461 A1
(43) Pub. Date: Jun. 18, 2026

(54) JIG FOR MANUFACTURING BATTERY MODULE, BATTERY MODULE, AND METHOD OF MANUFACTURING BATTERY MODULE

(71) Applicant: Samsung SDI Co., Ltd., Yongin-si (KR)

(72) Inventors: Cheorlhwan Kim, Yongin-si (KR); Jangyeong Im, Yongin-si (KR); Jongtaek Park, Yongin-si (KR); Sangik Lee, Yongin-si (KR)

(73) Assignee: Samsung SDI Co., Ltd., Yongin-si (KR)

(21) Appl. No.: 19/419,655

(22) Filed: Dec. 15, 2025

(30) Foreign Application Priority Data
Dec. 17, 2024 (KR) 10-2024-0189306

(51) Int. Cl. H01M 10/04

(52) U.S. Cl. CPC H01M 10/0404; H01M 10/0481

(57) ABSTRACT

Disclosed herein are a jig for manufacturing a battery module, a battery module, and a method of manufacturing a battery module. The jig may include: a first stationary end block configured to support one of outermost battery cells of a cell stack including a plurality of battery cells; a movable end block configured to support a remaining one of the outermost battery cells of the cell stack; a second stationary end block coupled to the movable end block; and a side plate configured to secure the first stationary end block and the second stationary end block and support a side surface of the cell stack. The movable end block may move along the side plate and apply pressure to the cell stack.

### CROSS-REFERENCE TO RELATED APPLICATIONS

This present application claims priority to and the benefit under 35 U.S.C. 119(a)-(d) of Korean Patent Application No. 10-2024-0189306, filed on Dec. 17, 2024, in the Korean Intellectual Property Office, the entire disclosure of which is incorporated herein by reference.

### FIELD

The present disclosure relates to a jig for manufacturing a battery module, a battery module, and a method of manufacturing the battery module, and more particularly, to a jig for manufacturing a battery module which includes a movable end block and applies pressure to a cell stack by moving the movable end block, a battery module, and a method of manufacturing the battery module.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly consisting of a positive electrode and a negative electrode, a case that accommodates the electrode assembly, a terminal part connected to the electrode assembly, etc.

Taking into account convenience, production time, and cost, a module for evaluation with a smaller number of battery cells than an actual module may be used to perform a test for evaluating the thermal propagation delay performance of a secondary battery module. Conventional modules for evaluation are completed by placing battery cells and end blocks for supporting the battery cells in manufacturing equipment to which a pressure sensor is attached, and fabricating a jig by fastening a side plate to the end blocks.

However, in manufacturing of such a conventional module for evaluation, trial and error may be required to fabricate the jig that meets a desired pressure. Alternatively, the evaluation module may be manufactured by allowing extra space in dimensions of the side plate and filling a remaining space with an insulation sheet or plate. Furthermore, in the case where the number of evaluation cells in the module changes or the insulation sheet is replaced, the previously fabricated jig may become unusable, requiring the fabrication of an additional jig.

The above information disclosed in this Background section is for enhancement of understanding of the background of the present disclosure, and therefore, it may contain information that does not constitute related (or prior) art.

### SUMMARY

Embodiments of the present disclosure are directed to providing a jig for manufacturing a battery module which includes a movable end block and applies pressure to a cell stack by moving the movable end block, a battery module, and a method of manufacturing the battery module.

However, the technical problem to be solved by the present disclosure is not limited to the problems described herein, and other problems not mentioned herein, and aspects and features of the present disclosure that would address such problems, will be clearly understood by those skilled in the art from the description of the present disclosure herein.

A jig for manufacturing a battery module according to embodiments of the present disclosure may include: a first stationary end block configured to support one of outermost battery cells of a cell stack including a plurality of battery cells; a movable end block configured to support a remaining one of the outermost battery cells of the cell stack; a second stationary end block coupled to the movable end block; and a side plate configured to secure the first stationary end block and the second stationary end block and support a side surface of the cell stack. The movable end block may move along the side plate and apply pressure to the cell stack.

In embodiments, the jig may further include a movable component coupled to the second stationary end block and configured to move the movable end block.

In embodiments, the jig may further include a pressure sensor interposed between the movable end block and the movable component.

In embodiments, the movable component may be a main screw having a thread formed on a surface thereof so that the main screw moves the movable end block according to rotation thereof.

In embodiments, the jig may further include at least one support component configured to support at least one point of the movable end block, with the movable component having moved the movable end block and applied pressure to the cell stack.

In embodiments, the support component may be a sub screw having a thread formed on a surface thereof so that the sub screw moves according to rotation thereof and supports the movable end block.

In embodiments, the support component may move until just before a measured value of the pressure sensor varies, with the movable component having moved the movable end block and applied pressure to the cell stack, and support the movable end block.

In embodiments, the pressure sensor may be removable by retracting the movable component, with the support component supporting the movable end block.

In embodiments, the side plate may have a shape formed by bending a flat plate multiple times, and may support the side surface and a bottom surface of the cell stack.

A battery module according to embodiments of the present disclosure may include: a cell stack including a plurality of battery cells; and a jig for manufacturing a battery module, the jib being configured to apply pressure to the cell stack. The jig may include: a first stationary end block configured to support one of outermost battery cells of the cell stack; a movable end block configured to support a remaining one of the outermost battery cells of the cell stack; a second stationary end block coupled to the movable end block; and a side plate configured to secure the first stationary end block and the second stationary end block and support side surfaces of the plurality of battery cells. The movable end block may move along the side plate and apply pressure to the cell stack.

In embodiments, the battery module may further include a movable component coupled to the second stationary end block and configured to move the movable end block.

In embodiments, the battery module may further include a pressure sensor interposed between the movable end block and the movable component.

In embodiments, the battery module may further include at least one support component configured to support at least one point of the movable end block, with the movable component having moved the movable end block and applied pressure to the cell stack.

In embodiments, the support component may move until just before a measured value of the pressure sensor varies, with the movable component having moved the movable end block and applied pressure to the cell stack, and support the movable end block.

In embodiments, the pressure sensor may be removable by retracting the movable component, with the support component supporting the movable end block.

A method of manufacturing a battery module according to embodiments of the present disclosure may include: providing a cell stack including a plurality of battery cells; providing a first stationary end block that supports one of outermost battery cells of the cell stack; providing movable end block that supports a remaining one of the outermost battery cells of the cell stack; providing a second stationary end block coupled to the movable end block; securing the first stationary end block and the second stationary end block to a side plate that supports a side surface of the cell stack; and applying pressure to the cell stack by moving the movable end block.

In embodiments, the method may further include coupling a movable component to the second stationary end block, the movable component being provided to move the movable end block.

In embodiments, the method may further include interposing a pressure sensor between the movable end block and the movable component.

In embodiments, the method may further include supporting at least one point of the movable end block by at least one support component, with the movable component having moved the movable end block and applied pressure to the cell stack.

In embodiments, the method may further include retracting the movable component and removing the pressure sensor, with the support component supporting the movable end block.

According to embodiments of the present disclosure, a movable end block may be included, and a cell stack may be pressed by moving the movable end block. Therefore, trial and error in an initial stage of a manufacturing process may be eliminated, and the manufacture of a battery module that meets the desired pressure may be facilitated.

According to embodiments of the present disclosure, the movable structure of the movable end block provides flexibility for dimensional changes and enables evaluation of various cell thicknesses and quantities, thereby removing the need for additional jig fabrication when an insulation sheet, cell type, or cell quantity is changed.

According to embodiments of the present disclosure, during battery module manufacturing, module may be manufactured regardless of cell swelling caused by open circuit voltage (OCV), thereby enabling evaluation under various OCV conditions.

According to embodiments of the present disclosure, manufacturing the battery module can be performed regardless of the dimensions of the battery module, thus enabling pre-fabrication of a jig, and reducing manufacturing time and cost.

According to embodiments of the present disclosure, the jig used for battery module manufacturing may be universally compatible, thereby enabling shared use across different projects.

According to embodiments of the present disclosure, the battery module may be manufactured at a desired pressure value by including a pressure sensor interposed between the movable end block and the movable component. Even if deviations occur due to internal cells of the battery module or other factors, the battery module may be manufactured at the desired pressure value without being affected by the deviations.

However, aspects and features of the present disclosure are not limited to those described herein, and other aspects and features not mentioned will be clearly understood by a person skilled in the art from the detailed description, described herein.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings.

FIG. 1A is a top perspective view of a prismatic secondary battery.

FIG. 1B is a sectional view taken along line I-I′ of FIG. 1A.

FIG. 2 is a diagram illustrating a conventional battery module for evaluation.

FIG. 3A is a side view and FIG. 3B is a front view illustrating a battery module including a jig for manufacturing a battery module according to embodiments of the present disclosure.

FIG. 4 is a flowchart for describing a method of manufacturing a battery module according to embodiments of the present disclosure.

### DETAILED DESCRIPTION

Exemplary embodiments of the present disclosure will be described herein in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own disclosure in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed herein may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

The present disclosure will be described in detail with reference to the attached drawings.

Examples of secondary batteries include a coin type, a cylindrical type, a prismatic type, and a pouch type. The present disclosure is basically applicable to a prismatic secondary battery. Therefore, the prismatic secondary battery will first be briefly described prior to description of embodiments of the present disclosure.

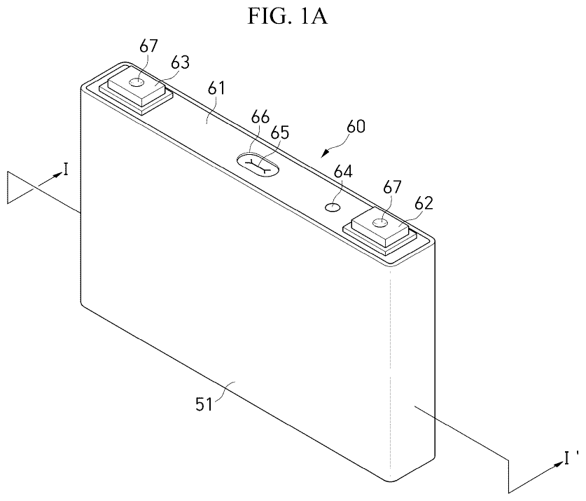

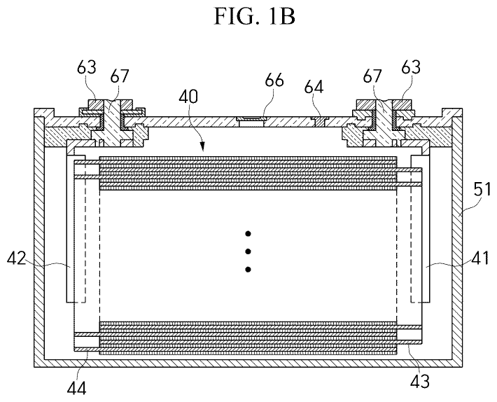

FIG. 1A is a top perspective view of the prismatic secondary battery. FIG. 1B is a cross-sectional view taken along line I-I′ of FIG. 1A.

First, the external appearance of the prismatic secondary battery illustrated in FIG. 1A will be described.

A casing 51 defines an overall appearance of the prismatic secondary battery, and may be made of conductive metal, such as aluminum, aluminum alloy, or nickel-plated steel. In addition, the casing 51 may provide a space for accommodating an electrode assembly therein.

A cap assembly 60 may include a cap plate 61 that covers the opening of the casing 51, and the cap assembly 60 and the cap plate 61 may be made of a conductive material. Here, a first terminal 63 and a second terminal 62 may be electrically connected to respective positive and negative (or negative and positive) electrodes inside the casing, and may be installed to protrude outward through the cap plate 61.

The cap plate 61 may be equipped with an electrolyte injection port 64 formed to install a sealing plug, and a vent 66 formed with a notch 65. The vent 66 is for degassing the secondary battery, i.e., for discharging gas generated inside the secondary battery.

With reference to FIG. 1B, the internal structure of the prismatic secondary battery and the coupling structure with the cap assembly 60 will be described.

As illustrated in FIG. 1B, the prismatic secondary battery may basically include an electrode assembly 40, a first current collector part 41, a first terminal 62, a second current collector part 42, a second terminal 63, and a cap assembly 60.

The electrode assembly 40 may be formed by winding or stacking a laminate of a first electrode plate, a separator, and a second electrode plate, which are in the form of a plate or a film. When the electrode assembly 40 is a wound laminate, it may have a winding axis parallel to the longitudinal direction of the casing. The electrode assembly 40 may be of a stack type rather than a winding type, but the shape of the electrode assembly 40 is not limited in the present disclosure. In addition, the electrode assembly 40 may be a Z-stack electrode assembly in which a first electrode plate and a second electrode plate are inserted into both sides of a separator bent into a Z-stack. Furthermore, the electrode assembly 40 may consist of one or more electrode assemblies, which are stacked such that their long sides are adjacent to each other and accommodated in the casing, and the number of electrode assemblies is not limited in the present disclosure. The electrode assembly 40 may have a first electrode plate that acts as a negative electrode and a second electrode plate that acts as a positive electrode, or vice versa.

The first electrode plate may be formed by applying a first electrode active material, such as graphite or carbon, to a first electrode current collector plate made of metal foil, such as copper, copper alloy, nickel, or nickel alloy. The first electrode plate may include a first electrode tab (or first uncoated part) 43, which is a region without application of the first electrode active material. The first electrode tab 43 may act as a current flow passage between the first electrode plate and the first current collector part 41. In some examples, the first electrode tab 43 may be formed by cutting the first electrode plate to protrude to one side in advance when manufacturing the first electrode plate, and may protrude further to one side than the separator without separate cutting.

The second electrode plate may be formed by applying a second electrode active material such as transition metal oxide to a substrate made of metal foil, such as aluminum or aluminum alloy. The second electrode plate may include a second electrode tab (or second uncoated part) 44, which is a region without application of the second electrode active material. The second electrode tab 44 may act as a current flow passage between the second electrode plate and the second current collector part 42. In some examples, the second electrode tab 44 may be formed by cutting the second electrode plate to protrude to the other side in advance when manufacturing the second electrode plate, and may protrude further to the other side than the separator without separate cutting.

In some embodiments, the first electrode tab 43 may be located on the right end side of the electrode assembly 40, and the second electrode tab 44 may be located on the left end side of the electrode assembly 40. Alternatively, the first electrode tab 43 and the second electrode tab 44 may be located on one end side of the electrode assembly 40 in the same direction. Here, the left and the right are represented based on the secondary battery illustrated in FIG. 1 for convenience of explanation, and they may change in position when the secondary battery is rotated left and right or up and down.

The separator functions to prevent a short circuit between the first electrode plate and the second electrode plate while permitting migration of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate extend from both ends of the electrode assembly 40 as described herein, respectively. In some embodiments, the electrode assembly 40 may be accommodated together with an electrolyte in the casing 51.

In the electrode assembly 40, the first current collector part 41 and the second current collector part 42 may be welded and connected to the first electrode tab 43 extending from the first electrode plate and the second electrode tab 44 extending from the second electrode plate, respectively.

The first current collector part 41 and the second current collector part 42 are connected to the first terminal 62 and the second terminal 63, as described with reference to FIG. 1A, through terminal pins 67, respectively. In some embodiments, the terminal pins 67 may each have an outer peripheral surface that is threaded, and may be fastened to the first terminal 62 and the second terminal 63 by screwing. However, the present disclosure is not limited thereto. For example, the terminal pins 67 may also be coupled to the first terminal 62 and the second terminal 63 by riveting or welding.

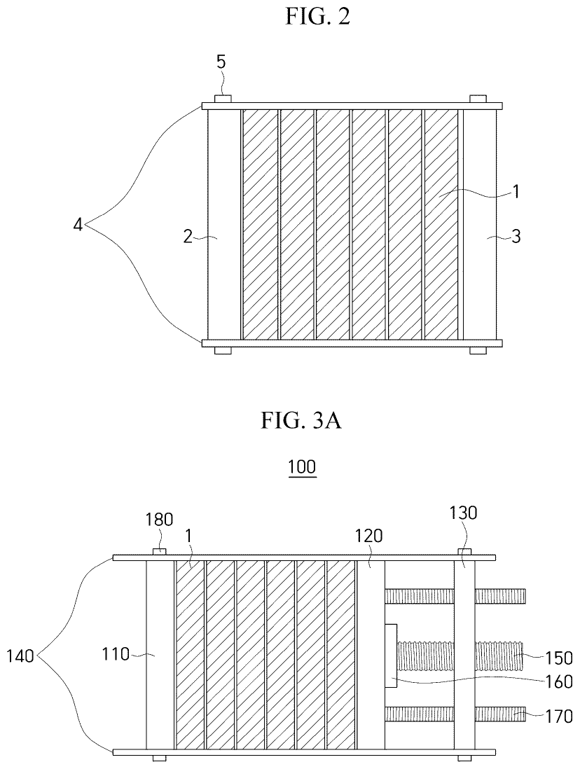

FIG. 2 is a diagram illustrating a conventional battery module for evaluation.

Referring to FIG. 2, the conventional battery module for evaluation may be completed by placing battery cells 1 and end blocks 2 and 3 for supporting the battery cells 1 in manufacturing equipment to which a pressure sensor is attached, and fabricating a jig by fastening a side plate 4 to the end blocks 2 and 3.

Various types of insulation sheets may be applied to the battery module, and the battery module may be evaluated, and the performance thereof may be compared. A distance between fastening holes formed in the side plate 4 for fastening the end blocks 2 and 3 is fixed, and the end blocks 2 and 3 are secured by tightening bolts 5 into the fastening holes. Here, there may be differences in thickness between the insulation sheets. Hence, in the case where various types of insulation sheets are applied for evaluation, a difference in the pressure of the fabricated battery module may occur.

TO eliminate the aforementioned difference, a conventional method of manufacturing the battery module for evaluation may include inserting spacers between the battery cells 1 and the end blocks 2 and 3.

Therefore, in the conventional manufacturing of the battery module for evaluation, trial and error may be required to fabricate a jig that meets a desired pressure. Alternatively, the battery module may be manufactured by allowing extra space in dimensions of the side plate 4 and filling a remaining space with an insulation sheet or plate. Furthermore, in the case where the number of evaluation cells in the battery module changes or the insulation sheet is replaced, the previously fabricated jig may become unusable, requiring the fabrication of an additional jig.

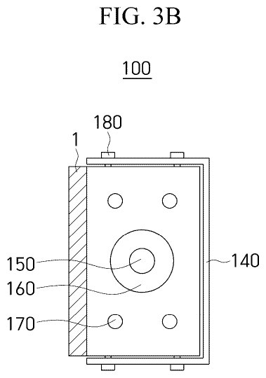

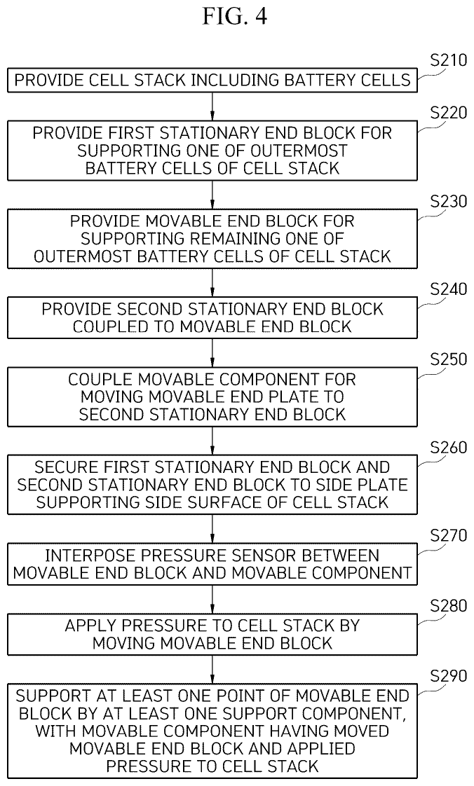

FIG. 3A is a side view and FIG. 4B is a front view illustrating a battery module including a jig for manufacturing a battery module according to embodiments of the present disclosure.

Referring to FIGS. 3A and 3B, the battery module according to embodiments of the present disclosure may include a cell stack 1 and a jig 100 for manufacturing a battery module.

The cell stack 1 may include a plurality of battery cells, and may include an insulation sheet for evaluating thermal propagation delay performance. Furthermore, the cell stack 1 may further include a heater for a thermal propagation trigger or auxiliary materials such as other blocks.

The jig 100 for manufacturing a battery module may include a first stationary end block 110, a movable end block 120, a second stationary end block 130, a side plate 140, a movable component 150, a pressure sensor 160, a support component 170, and a fastening component 180.

The first stationary end block 110 may support one of outermost battery cells of the cell stack 1. The first stationary end block 110 may be secured to the side plate 140, which will be described herein, by the fastening component 180, which will be described herein.

The movable end block 120 may support a remaining one of the outermost battery cells of the cell stack 1. The movable end block 120 may not be secured to the side plate 140, which will be described herein, unlike the first stationary end block 110 or the second stationary end block 130, which will be described herein, and may move along the side plate (140) to apply pressure to the cell stack 1.

The second stationary end block 130 may be coupled to the movable end block 120. The second stationary end block 130 may be secured to the side plate 140, which will be described herein, by the fastening component 180, which will be described herein.

The side plate 140 may secure the first stationary end block 110 and the second stationary end block 130 and support side surfaces of the cell stack 1. The side plate 140 may secure the first stationary end block 110 and the second stationary end block 130 through the fastening component 180, which will be described herein. In embodiments, the side plate 140 may have a shape formed by bending a flat plate multiple times, and may support side and bottom surfaces of the cell stack 1. For example, as illustrated in (b) of FIG. 3, the side plate 140 may be formed by bending a flat plate into a “C” shape, and may support the side and bottom surfaces of the cell stack 1. The shape of the side plate 140 shown in (b) of FIG. 3 may be according to embodiments, and any shape may be applied thereto as long as the side plate 140 can support the side and bottom surfaces of the cell stack 1.

The movable component 150 may be coupled to the second stationary end block 130, and may move the movable end block 120. The movable end block 120 may move along the movable component 150 to apply pressure to the cell stack 1. In embodiments, as shown in (a) of FIG. 3, the movable component 150 may be a main screw having a thread formed on a surface thereof, enabling the main screw to move the movable end block 120 according to rotation thereof. The configuration of the movable component 150 configured as a main screw, as shown in (a) of FIG. 3, may be according to embodiments, and any configuration may be applied thereto as long as it can achieve the purpose of moving the movable end block 120.

The pressure sensor 160 may be interposed between the movable end block 120 and the movable component 150, and may measure the pressure applied to the cell stack 1. In embodiments, the pressure sensor 160 may include a load cell.

At least one support component 170 may support at least one point of the movable end block 120, with the movable component 150 having moved the movable end block 120 and applied pressure to the cell stack 1. In embodiments, as illustrated in (b) of FIG. 3, the support component 170 may include four support components, which support four points around a portion where the movable end block 120 is coupled to the movable component 150. Furthermore, the support component 170 may be a sub screw having a thread formed on a surface thereof, enabling the sub screw to move according to rotation thereof and support the movable end block 120. The configuration of the support component 170 configured as a sub screw, as shown in (b) of FIG. 3, may be according to embodiments, and any configuration may be applied thereto as long as it can achieve the purpose of supporting the movable end block 120.

The at least one support component 170 may move until just before a measured value of the pressure sensor 160 varies, with the movable component 150 having moved the movable end block 120 and applied pressure to the cell stack 1, and may support the movable end block 120. The fact that the measured value of the pressure sensor 160 varies when the at least one support component 170 is gradually moved, with the movable component 150 having moved the movable end block 120 and applied pressure to the cell stack 1, may indicate that the at least one support component 170 influences the pressure applied to the movable end block 120 by the movable component 150. Therefore, to prevent the aforementioned influence, the at least one support component 170 may move only to a position just before the measured value of the pressure sensor 160 varies, and support the movable end block 120.

In embodiments, the pressure sensor 160 may be removed by retracting the movable component 150, with the support component 170 supporting the movable end block 120. Since the pressure sensor 160 is not an essential component after the battery module has been manufactured, the pressure sensor 160 may be removed after being used for pressure measurement.

At least one fastening component 180 may secure the first stationary end block 110 to the side plate 140, and may secure the second stationary end block 130 to the side plate 140. In embodiments, the fastening component 180 may be a bolt.

FIG. 4 is a flowchart for describing a method of manufacturing a battery module according to embodiments of the present disclosure.

Referring to FIG. 4, the method of manufacturing the battery module according to embodiments of the present disclosure may include steps S210 to S220.

Step S210 may include providing a cell stack including a plurality of battery cells.

Step S220 may include providing a first stationary end block that supports one of outermost battery cells of the cell stack.

Step S230 may include providing a movable end block that supports a remaining one of the outermost battery cells of the cell stack.

Step S240 may include providing a second stationary end block that is coupled to the movable end block.

Step S250 may include coupling a movable component configured to move the movable end block, to the second stationary end block.

Step S260 may include securing the first stationary end block and the second stationary end block to a side plate that supports side surfaces of the cell stack.

Step S270 may include interposing a pressure sensor between the movable end block and the movable component.

Step S280 may include applying pressure to the cell stack by moving the movable end block.

Step S290 may include supporting at least one point of the movable end block using at least one support component, with the movable component having moved the movable end block and applied pressure to the cell stack.

In embodiments, the battery module manufacturing method according to the present disclosure may further include removing the pressure sensor by retracting the movable component, with the support component supporting the movable end block.

The herein-mentioned method of manufacturing the battery module according to embodiments of the present disclosure has been described with reference to the flowchart shown in the drawing. For brief explanation, the method has been illustrated and described as a series of blocks, but the present disclosure is not limited to the order of the blocks. In other words, some blocks may be executed simultaneously with other blocks or in a different order from those illustrated and described in this specification, and various diverges, flow paths, block sequences may also be implemented if they give the equivalent or similar results. In addition, to implement the method described in the specification, it is also possible not to demand all blocks.

In the description with reference to FIG. 4, each step may be further divided into additional steps, or some steps may be combined as fewer steps, based on implementation embodiments of the present disclosure. Furthermore, some steps may be omitted as needed, and a sequence of steps may be changed. In addition, despite other omitted description, the description given with reference to FIGS. 1A to 3 may be applied to the description given with reference to FIG. 4. Moreover, the description provided with reference to FIG. 4 may be applied to the description provided with reference to FIGS. 1A to 3.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material. Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}XₓO_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄(0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %.

Al may be used as the current collector, but the present disclosure may not be limited thereto.

A negative electrode active material may include a material capable of reversibly Intercalation/de-intercalation with respect to lithium ions, lithium metal, an alloy of lithium metal, a material capable of doping and dedoping with respect to lithium, or transition metal oxide.

The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99 wt. %, the binder of 0.5 wt. % to 5 wt. %, and the conductive material of 0 wt. % to 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth) acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described herein in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. A jig for manufacturing a battery module, comprising:
a first stationary end block configured to support one of outermost battery cells of a cell stack including a plurality of battery cells;
a movable end block configured to support a remaining one of the outermost battery cells of the cell stack;
a second stationary end block coupled to the movable end block; and
a side plate configured to secure the first stationary end block and the second stationary end block and support a side surface of the cell stack,
wherein the movable end block moves along the side plate and applies pressure to the cell stack.

2. The jig as claimed in claim 1, further comprising a movable component coupled to the second stationary end block and configured to move the movable end block.

3. The jig as claimed in claim 2, further comprising a pressure sensor interposed between the movable end block and the movable component.

4. The jig as claimed in claim 2, wherein the movable component comprises a main screw having a thread formed on a surface thereof so that the main screw moves the movable end block according to rotation thereof.

5. The jig as claimed in claim 3, further comprising at least one support component configured to support at least one point of the movable end block, with the movable component having moved the movable end block and applied pressure to the cell stack.

6. The jig as claimed in claim 5, wherein the support component comprises a sub screw having a thread formed on a surface thereof so that the sub screw moves according to rotation thereof and supports the movable end block.

7. The jig as claimed in claim 5, wherein the support component moves until just before a measured value of the pressure sensor varies, with the movable component having moved the movable end block and applied pressure to the cell stack, and supports the movable end block.

8. The jig as claimed in claim 5, wherein the pressure sensor is removable by retracting the movable component, with the support component supporting the movable end block.

9. The jig as claimed in claim 8, wherein the side plate has a shape formed by bending a flat plate multiple times, and supports the side surface and a bottom surface of the cell stack.

10. A battery module comprising:
a cell stack comprising a plurality of battery cells; and
a jig for manufacturing a battery module, the jib being configured to apply pressure to the cell stack,
wherein the jig comprises:
a first stationary end block configured to support one of outermost battery cells of the cell stack; a movable end block configured to support a remaining one of the outermost battery cells of the cell stack; a second stationary end block coupled to the movable end block; and a side plate configured to secure the first stationary end block and the second stationary end block and support side surfaces of the plurality of battery cells,
wherein the movable end block moves along the side plate and applies pressure to the cell stack.

11. The battery module as claimed in claim 10, further comprising a movable component coupled to the second stationary end block and configured to move the movable end block.

12. The battery module as claimed in claim 11, further comprising a pressure sensor interposed between the movable end block and the movable component.

13. The battery module as claimed in claim 12, further comprising at least one support component configured to support at least one point of the movable end block, with the movable component having moved the movable end block and applied pressure to the cell stack.

14. The battery module as claimed in claim 13, wherein the support component moves until just before a measured value of the pressure sensor varies, with the movable component having moved the movable end block and applied pressure to the cell stack, and supports the movable end block.

15. The battery module as claimed in claim 13, wherein the pressure sensor is removable by retracting the movable component, with the support component supporting the movable end block.

16. A method of manufacturing a battery module, comprising:
providing a cell stack including a plurality of battery cells;
providing a first stationary end block that supports one of outermost battery cells of the cell stack;
providing a movable end block that supports a remaining one of the outermost battery cells of the cell stack;
providing a second stationary end block coupled to the movable end block;
securing the first stationary end block and the second stationary end block to a side plate that supports a side surface of the cell stack; and
applying pressure to the cell stack by moving the movable end block.

17. The method as claimed in claim 16, further comprising coupling a movable component to the second stationary end block, the movable component being provided to move the movable end block.

18. The method as claimed in claim 17, further comprising interposing a pressure sensor between the movable end block and the movable component.

19. The method as claimed in claim 18, further comprising supporting at least one point of the movable end block by at least one support component, with the movable component having moved the movable end block and applied pressure to the cell stack.

20. The method as claimed in claim 19, further comprising retracting the movable component and removing the pressure sensor, with the support component supporting the movable end block.
